(19) United States
(12) Patent Application Publication
(10) Pub. No.: US 2005/0282945 A1
(43) Pub. Date: Dec. 22, 2005

(54) Coating compositions

(75) Inventor: Tom V. Faris, Pataskala, OH (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Vampire Optical Coatings, Inc.

(21) Appl. No.: 11/157,563

(22) Filed: Jun. 21, 2005

Related U.S. Application Data
(60) Provisional application No. 60/581,426, filed on Jun. 21, 2004.

(51) Int. Cl. C08K 3/18; C08K 3/34

(52) U.S. Cl. 524/430; 524/492

(57) ABSTRACT

A silane-free coating composition includes a polar aprotic reactive diluent, a colloidal inorganic oxide, and a crosslinkable monomer that has a functionality of at least one.

The present application claims priority from U.S. provisional application No. 60/581,426 filed Jun. 21, 2004, which is herein incorporated by reference in its entirety.

### FIELD OF THE INVENTION

The present invention relates to coating compositions, methods of making and using the compositions, and, more particularly, to abrasion resistant coatings formed from the coating compositions.

### BACKGROUND

Abrasion resistant coatings that are deposited onto optical plastic substrates can provide abrasion resistance, chemical resistance, and enhance the hardness of the surface of the optical plastic substrates. This can in turn increase the useful lifetime of the optical plastic substrates. While the use of UV curing chemistry has allowed the formulation of coatings that improve the abrasion resistance of optical plastics, these coatings typically have several limitations.

UV curable coatings cannot readily be cured using conventional UV photoinitiators in conjunction with UV absorbing additives. That is, the absorbance of the UV absorbing additive competes too effectively with the photoinitiator, and polymerization of the coating does not occur. Within the prior art, this problem has been addressed by using red shifted UV photoinitiators, such as diphenyl (2,4,6 trimethylbenzoyl)-phosphine oxide (Darocur 4265) in combination with traditional UV absorbing additives. Since these initiators absorb longer wavelength UV energy, there is usually degradation in the surface hardness of coatings produced using this approach.

In essentially all cases where abrasion resistant coatings are applied to optical substrates, the refractive index of the coating is substantially different from that of the optical substrate. This refractive index mismatch causes an interference phenomena between the light reflecting from the air-abrasion resistant coating interface and the light reflecting from the abrasion resistant coating-optical substrate interface.

Specific cases of these interference phenomena, also know as rainbow, iridescence, oil slick effect, optical ripple, corona, interference fringes and Moiré fringes, are observable as brightly colored magenta and green reflections under high intensity fluorescent lighting. The degree of this effect is related to the difference between the refractive index of the underlying substrate and the abrasion resistant coating. This effect, hereinafter referred to as optical ripple, is known to cause problems for those firms that use abrasion resistant coated PET or polycarbonate film as the substrate for anti-reflective film preparation.

The optical ripple causes unwanted increases in the average reflectance of the finished product and also causes very specific optical effects on the anti-reflective film's surface. Optical ripple has also caused rejections and customer complaints due to the brightly colored magenta and green reflected colors when abrasion resistant coated PET is used as an overlay film on touch screens and membrane keypad applications. This phenomenon is also well known in the eyeglass industry.

U.S. Pat. No. 6,538,092, assigned to SDC Coatings, Inc., discloses a coating composition based upon thermally curable silane monomers and high refractive index colloidal metal particles. This invention addresses the need for materials wherein the refractive indices can be tuned to a particular value. Application of the composition to film substrates is, however, limited due to both the time and temperature necessary to fully develop the properties of the abrasion resistant coating.

U.S. Pat. No. 5,907,000, assigned to The Walman Optical Company, discloses an actinic radiation curable coating composition, based upon UV curable monomers and colloidal metal oxides, which exhibit an adjustable refractive index. The composition disclosed addresses the need for low optical ripple and the low thermal tolerance of plastic film substrates. These compositions rely upon silane coupling agents to provide dispersions that are usable as well as stable.

U.S. Pat. No. 6,727,334, assigned to DSM N.V., disclose an actinic radiation curable coating composition, which exhibits excellent storage stability, coatability and high surface hardness. This composition, however, requires the use of silane coupling agents to provide for coating stability.

### SUMMARY OF THE INVENTION

The present invention relates to a curable silane-free resin coating composition that comprises a polar aprotic reactive diluent, a colloidal inorganic oxide, and a crosslinkable monomer that has a functionality of at least one.

The coating composition can form coatings that exhibit high surface hardness, excellent abrasion resistance, high transparency, good adhesion to a variety of substrates, little or no ‘optical ripple’, and low optical haze. The coating composition can also include high loads of nano-particles, which act to modify the physical, mechanical, optical and electrical properties of the coatings.

The coating compositions can be radiation curable coatings that substantially filter UV radiation and are resistant to yellowing, hazing and loss of adhesion as a result of exposure to UV radiation for extended periods of time. The coating composition in accordance with the present invention can also be used to form coatings that selectively filter infrared radiation, coatings that exhibit EMI shielding properties, electro-static dissipative coatings, and coatings, which exhibit high refractive indices.

In an aspect of the invention the polar aprotic reactive diluent can comprise a cyclic tertiary amide. The cyclic tertiary amide can be, for example, a substituted lactam and/or a substituted isocyanurate that is free of (or has no) hydrogen attached to the amide groups of the lactam and/or isocyanurate. The substituted lactam and/or isocyanurate can include, for example, vinyl pyrollidinone, vinyl caprolactam, and 1,3,5-tris-(acryloxyethyl isocyanurate).

The colloidal inorganic oxide can include an oxide of an element selected from the group consisting of silicon, aluminum, titanium, zinc, germanium, indium, tin, antimony, and combinations thereof. The colloidal inorganic oxide can be present in the form of a sol and have a pH between about 1 and about 10. By way of example, the colloidal inorganic oxide can include a silical sol with an acidic pH, a colloidal antimony pentoxide sol, or a colloidal zinc antimony oxide sol and be provided in an amount by weight on a solids basis at about 1% to about 75%.

In another aspect of the invention, the crosslinkable monomer can comprise a multi-functional acrylate monomer, such as a dipentaerylthritol pentaacrylate. Optionally, the crosslinkable monomer can be a polar aprotic reactive diluent. For example, 1,3,5-tris-(acryloxyethyl)isocyanurate is a polar aprotic reactive diluent and a multi-functional acrylate monomer.

In an aspect of the invention, the silane-free coating composition can comprise by weight on a solids basis about 5% to about 55% of a trisubstituted isocyanurate, about 1% to about 75% of a colloidal inorganic oxide, and about 20% to about 60% of a multifunctional crosslinkable monomer. The silane-free coating composition can also include at least one of a solvent, UV absorber, infrared absorber, or a polymerization initiator.

### BRIEF DESCRIPTION OF THE DRAWINGS

Further features of the present invention will become apparent to those skilled in the art to which the present invention relates from reading the following description of the invention with reference to the accompanying drawings in which:

FIG. 1 is a plot illustrating the % reflectance with respect wavelength of a coating composition in accordance with an aspect of the invention.

FIG. 2 is a plot illustrating the UV transmission of a coating in accordance with an aspect of the invention.

### DETAILED DESCRIPTION

The present invention relates to silane-free resin coating composition that can be provided, for example, on an optical substrate. The coating composition provides for actinic radiation curable coatings that can form hard, clear abrasion resistant coatings. The cured coatings formed from the coating composition can exhibit desirable optical, electrical and mechanical properties, such as: low optical ripple, ESD functions, EMI shielding, selective infrared transmission, high abrasion and scratch resistance. The coating composition may optionally be formulated to filter essentially all UV radiation such that an underlying optical substrate to which the coating composition is applied is protected from damaging UV radiation and the usable lifetime of the optical substrate is extended.

The silane-free resin coating composition comprises a polar aprotic reactive diluent, a colloidal inorganic oxide, and a crosslinkable monomer that has a functionality of at least one. The polar aprotic reactive diluent readily disperses the colloidal inorganic oxide in the coating composition so that relatively high (e.g., up to about 75% by weight on solids basis) loads of colloidal inorganic oxide can be provided in the coating composition. The polar aprotic reactive diluent can also increase the surface energy or surface wetting capability of the coating composition so that the coating composition can be readily applied to a substrate (e.g., PET optical substrate) without any prior treatment to the substrate and the without the use of conventional dispersing equipment.

In an aspect of the invention, the polar aprotic reactive diluent can comprise a ditertiary amide; that is, an amide in which there is no hydrogen atom attached to the nitrogen atom in the molecule. An example of a ditertiary amide that can be used as the polar aprotic reactive diluent is a cyclic ditertiary amide with the following general formula: 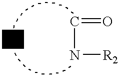
where R₁ represents a group of atoms necessary to complete the ring structure of the cyclic ditertiary amide, wherein R₁ may optionally be substituted, and R₂ is a reactive group, such as an alkene, acrylate, or epoxide. Examples of specific cyclic ditertiary amides that can be used as the polar aprotic diluent are substituted lactams, such as vinyl caprolactam and vinyl pyrrolidone, and substituted isocyanurates, such as multifunctional acrylates (e.g., 1,3,5-tris-(acryloxyethyl)isocyanurate, which is commercially available from Sartomer Company under the tradename SR368) and multifunctional epoxies (e.g., 1,3,5-tris-(2,3-epoxypropyl)-isocyanurate). 1,3,5-tris-(acryloxyethyl)isocyanurate can be advantageously employed as the polar aprotic reactive diluent because it unlike the vinyl lactams is resistant to acid hydrolysis during storage.

The ditertiary amide polar aprotic reactive diluent can be used alone or in combination with another polar aprotic reactive diluent. The other polar aprotic reactive diluent can be a ditertiary amide or another compound that is not a ditertiary amide. By way of example, the other polar aprotic reactive diluent can be tetrahydrofurfuryl acrylate.

The polar aprotic reactive diluent can be provided in the coating composition in an amount effective to readily disperse the collodial inorganic oxide. This amount can vary depending on the specific amount of colloidal inorganic provided in the coating. In an aspect of the invention, the amount of polar aprotic reactive diluent included in the coating composition can be about 5% to about 55% by weight of the coating composition.

The colloidal inorganic oxide dispersed in the polar aprotic reactive diluent of the coating composition can comprise at least one oxide particle of an element selected from the group consisting of silicon, aluminum, zirconium, titanium, zinc, germanium, indium, tin, antimony, cerium, and combinations thereof. Examples of oxides of these elements that can be used in accordance with present invention include silica, alumina, zirconia, titania, zinc oxide, germanium oxide, indium oxide, tin oxide, indium-tin oxide (ITO), antimony oxide, zinc antimony oxide, and cerium oxide. Of these, colloidal silica, alumina, zirconia, and antimony oxide are desirable from the viewpoint of high hardness. Colloidal silica is particularly desirable in imparting abrasion resistance to the coating. Antimony oxide is also particularly desirable in promoting electrostatic dissipation of the coating.

The average diameter of the particles of colloidal inorganic oxide particles can be about 0.0001 μm to about 2 μm, more particularly, about 0.001 μm to about 0.2 μm. If the number average particle diameter is more than 2 μm, transparency and surface conditions of the cured product tend to be impaired.

The colloidal inorganic oxides can be used either individually or in combinations of two or more. In addition, the colloidal inorganic oxide particles can be present in the form of a powder or a solvent dispersion sol. When the colloidal inorganic oxide particles are in the form of a dispersion, an organic solvent can be used as a dispersion medium.

Examples of commercially available colloidal silica that can be used in accordance with the present invention include colloidal silica sol, such as IPA-ST, MEK-ST, NBA-ST, XBA-ST, DMAC-ST, ST-UP, ST-OUP, ST-20, ST-40, ST-C, ST-N, ST-O, ST-50, ST-OL, which are commercially available from Nissan Chemical Industries, Ltd., and NANOPOL and NANOCRYL, which are commercially available from Hanse Chemie, as well as powdery colloidal silica, such as AEROSIL 130, AEROSIL 300, AEROSIL 380, AEROSIL TT600, and AEROSIL OX50, which are commercially available from Japan Aerosil Co., Ltd., Sildex H31, H32, H51, H52, H121, H122, which are commercially available from Asahi Glass Co., Ltd., E220A, E220 which are commercially available from Nippon Silica Industrial Co., Ltd., SYLYSIA470, which are commercially available from Fuji Silycia Chemical Co. Ltd., and SG Flake, which are commercially available from Nippon Sheet Glass Co., Ltd.

Other commercially available colloidal inorganic oxides include colloidal antimony oxide, such as AMT-130S and AMT-330S, which are commercially available from Nissan Chemical America, colloidal zinc antimony oxide sol, such as CELNAX CX-Z653M-F, CELNAX Z641 MF, and S22N, which are commercially available from Nanogate GmbH.

Still other commercially available colloidal inorganic oxides can include aqueous dispersion products of alumina, such as Alumina Sol-100, -200, -520, which are commercially available from Nissan Chemical Industries, Ltd., isopropanol dispersion products of alumina, such as AS-150T, which is commercially available from Sumitomo Osaka Cement Co., Ltd., toluene dispersion products of alumina, such as AS-150T, which is commercially available from Sumitomo Osaka Cement Co., Ltd., aqueous dispersion products of zinc antimonate powder, such as CELNAX, which is commercially available from Nissan Chemical Industries, Ltd., aqueous dispersion sol of antimony doped-tin oxide, such as SN-100D, which is commercially available from Ishihara Sangyo Kaisha, Ltd., and aqueous dispersion products of cerium oxide, such as Needral, which is commercially available from Taki Chemical Co., Ltd.

The amount of colloidal inorganic oxide provided in the coating composition can be about 1% to about 75% by weight based on the coating solids. The weight percentage of the colloidal inorganic oxide used in the coating composition can depend on the specific colloidal oxide as well as the desired properties of the coating. In one example, the colloidal inorganic can be an antimony pentoxide that is provided in the coating composition at a weight percentage of about 20% to about 30% based on the coating solids. In another example, the colloidal inorganic oxide can be zinc antimony oxide that is provided in the coating composition at a weight percentage of about 40% to about 70% based on the coating solids.

The crosslinkable monomer with a functionality of at least one can comprise any monomer, oligomer, or combination of monomers and/or oligomers that can form a coating layer when applied to a surface of a substrate and cured, for example, by actinic radiation. Such monomers and oligomers are well known to those of skill in the art. In one aspect of the invention, the monomers can be liquid at room temperature, highly branched, actinic radiation curable, and have a multi(meth)acrylate functionality. As used herein, term “(meth)acrylate” and its variants mean “acrylate, methacrylate and mixtures thereof.” Examples include polyester (meth)acrylates, polyurethane (meth)acrylates, polyester-urethane acrylates, acrylated epoxy, polyepoxides compounds and mixtures thereof.

The (meth)acrylate-functional monomers and oligomers employed in the coating composition can be selected to provide the desired blend of film hardness and index of refraction to the cured coating. To develop hardness, the coating composition can include at least one (meth)acrylate-functional monomer that has a functionality of at least three. Exemplary of monomers or oligomers of this type are dipentaerythritol hydroxy pentacrylate, di (trimethylol propane) tetraacrylate, urethane acrylates and other multifunctional urethanes, trimethylol propane triacrylate and pentaerythritol tetraacrylate. Optional monomers can include epoxy functional non-silane compounds such as trimethylol propane triepoxide. If epoxy functional monomers are used, the curable composition preferably also contains a cationic polymerization photoinitiator, such as one or a mixture of triarylsulfonium hexafluoroantimonate salts.

Other (meth)acrylate monomers or oligomers that are used can be chosen from the wide variety of known monomers and oligomers. The other (meth)acrylate monomers or oligomers can include at least one aromatic monomer, such as bisphenol A diacrylate or diacrylate esters of a Bisphenol A diepoxide. The aromatic (meth)acrylates form polymers with higher indices of refraction, and these accordingly are valuable in adjusting the index of refraction of the coating. Also valuable are the sulfur-containing (meth)acrylates. Halogenated (meth)acrylates, such as tetrabromo Bisphenol A diacrylate are also valuable since the presence of halogen tends to substantially increase the index of refraction of the resulting polymer.

The (meth)acrylate-functional monomers and oligomers (the term (meth)acrylate referring to both the acrylate and the methacrylate radicals) can also desirably include di(meth)acrylates and may include lower molecular weight monomers, such as (meth)acrylic acid and methylmethacrylate.

In another aspect of the invention, the crosslinkable monomer can be the same compound as the polar aprotic reactive diluent. For example, where the polar aprotic reactive diluent is a trifunctional substituted isocyanurate, such as 1,3,5-tris-(acryloxyethyl)isocyanurate, the polar aprotic reactive diluent can also function as the crosslinkable monomer.

Optionally, the silane-free coating composition in accordance with the present invention can further include a polymerization initiator to initiate curing of the crosslinkable monomer. The polymerization initiator can include, for example, a photoinitiator and/or thermal initiator that is used alone or in combination with a photosensitizer and/or accelerator. The photoinitiatior can comprise an actinic radiation initiator (e.g., UV initiator), such as benzophenone-type initiators, phosphine oxides, acetophenone derivatives, and cationic photoinitiators such as triaryl sulfonium salts and aryliodonium salts. Examples include benzophenones, 4-methylbenzophenone, benzyl dimethyl ketal, diethoxy acetophenone, benzoin ethers, thioxanthones, 1-hydroxycyclohexyl phenyl ketone (Irgacure 184 from Ciba Corp), 2-hydroxy-2-methyl-1-phenol-propane-1-one, 4-(2-hydroxyethoxy)phenyl-(2-hydroxy-2-methylpropyl) ketone, 2,4,6-trimethylbenzoyl diphenylphosphine oxide, bis (2,6-dimethoxybenzoyl)-2,4,4-trimethylpentyl phosphine oxide; 2,2-dimethoxy-2-phenyl acetophenone; 2-benzyl-2-N,N-dimethylamino-1-(4-morpholinophenyl)-1-butanon, and 2-methyl-1-[4-(methylthio)phenyl]-2-morpholino propan-1-one.

The polymerization initiator can also be a free radical initiator that generates radicals upon exposure to heat rather than light (e.g., “thermal initiators”). For example, various peroxide initiators, can be used as a thermal initiator. The thermal initiator can be used alone or in combination with the photoinitiator.

Commercially available photoinitiators that can be used in accordance with the present invention include Darocur 1173 (2-hydroxy-2-methyl-1-phenyl-propan-1-one), Irgacure 184 (1-hydroxycyclohexyl phenyl ketone), Darocur 4265 (50% 2-hydroxy-2-methyl-1-phenyl-1-one and 50% 2,4,6-trimethylbenzoyldiphenylphosphine oxide), Irgacure 907 (2-methyl-1-[4-(methylthio)phenyl]-2-morpholino propan-1-one), Irgacure 1700 (25% bis (2,6-dimethoxybenzoyl)-2,4,-4-trimethylpentyl phosphine oxide and 75% 2-hydroxy-2-methyl-1-phenyl-propan-1-one), benzophenone, Irgacure 819 (BAPO phenyl bis(2,4,6-trimethylbenzoyl)-phosphine oxide), Lucrin (MAPO diphenyl(2,4,6-trimethylbenzoyl phosphine oxide), and Irgacure 651 (alpha, alpha-dimethoxy-alpha-phenyl acetophenone), each of which is commercially available from Ciba Geigy.

Photosensitizers and accelerators can include but are not limited to ITX (isopropyl thioxanthone, Aceto), and CTX (chlorothioxanthone), quinones such as camphorquinone, Michler's Ketone (4,4′-bis(dimethylamino)benzophenone, thioxanthone, benzanthrone, triphenyl acetophenone and fluorenone (each of which is commercially available from Aldrich), dimethylethanolamine, methyldiethanolamine, triethanolamine, DMPT (N,N-dimethyl-para-toluidine), MHPT (N-[2-hydroxyethyl]-N-methyl-para-toluidine), ODAB (octyl-para-N,N-dimethylamino benzoate), and EDAB (ethyl-para-N,N-dimethylamino benzoate), each of which is commercially available from Ciba Geigy.

Free radical inhibitors can include but are not limited to N-nitroso-N-phenylhydroxylamine, ammonium salt, tris[N-nitroso-N-phenylhydroxylamine, aluminum salt, p-methoxyphenol MEHQ, hydroquinone and substituted hydroquinones, pyrogallol, phenothiazine, and 4-ethyl catechol. UV absorbers include hydroxyphenyl benzotriazole.

Additional photoinitiators and cure altering agents are described in U.S. Pat. No. 6,130,270, the contents of which are hereby incorporated by reference.

The coating composition can also include one or more aqueous and/or organic solvents that facilitate application of the coating composition to a substrate and preparation of a smooth defect free coating surface without substantially inhibiting polymerization of the crosslinkable monomer and dispersion of the colloidal inorganic in the coating composition. Examples of organic solvents that can be used in accordance with the present invention to readily disperse the colloidal inorganic oxides include alcohols, such as methanol, ethanol, isopropanol, butanol, and octanol, ketones, such as acetone, methyl ethyl ketone, methyl isobutyl ketone, and cyclohexanone, esters, such as ethyl acetate, butyl acetate, ethyl lactate, and butyrolactone, ethers, such as ethylene glycol monomethyl ether and diethylene glycol monobutyl ether, aromatic hydrocarbons, such as benzene, toluene, and xylene; and amides, for example dimethylformamide, dimethyl acetamide, and N-methylpyrrolidone. Of these organic solvents, methanol, isopropanol, butanol, methyl ethyl ketone, methyl isobutyl ketone, ethyl acetate, butyl acetate, toluene, xylene, and dimethyl formamide can be most readily used.

The coating composition in accordance with the present can optionally include additives, such as UV absorbers, infrared absorbers blocking agents, leveling agents, antioxidants, preservatives, inorganic and organic fillers, wettability improvers, and coating surface improvers. The levels of addition of such additives relative to coating composition depends on the kinds of additives, the object of use of each additive, the intend used of the coating composition, and the mode of use of the coating composition.

By way of example, the coating composition can further include by weight about 0.10% to about 10% of UV absorber, such as benzotriazole and/or benozotriazene.

In accordance with another aspect of the invention, the coating composition can include a multi-functional (meth) acrylate monomers from about 20 to about 60 weight percent, polar aprotic reactive diluents from about 5 to about 55 weight percent, UV absorbers between about 0.10 and about 10 weight percent, colloidal inorganic oxides from about 1.0 to about 75 weight percent based on coating solids as well as solvents in the proper amounts to provide efficient cure and a smooth defect free surface.

In a further aspect of the invention, the coating composition can be comprised of a multi-functional acrylate monomer, such a dipentaearythritol pentaacrylate, colloidal metal oxide sol, such as, colloidal silica with a surface pH between 1 and 7; a polar aprotic reactive diluent, such as 1,3,5 tris (acryloxyethyl isocyanurate), which, while not choosing to be bound by any particular theory, stabilizes the colloidal dispersion via hydrogen bonding and thereby promotes storage and stability during the coating, process photoinitiators capable of initiating UV polymerization and solvents in amounts to facilitate preparation of smooth defect free coated surfaces.

The coating composition of the invention can be formulated by mixing the crosslinkable monomer, polar aprotic reactive diluent, colloidal inorganic oxide and other components, such as additives, heating the formulation to dissolve the monomer, polar aprotic reactive diluent and other components, and then further admixing the heated mixture. The resulting coating composition of the invention can then be applied to a solid substrate by well-known techniques, such as hand coating comprising brush coating, etc., roll coating, gravure coating, gravure offset coating, curtain flow coating, reverse coating, screen printing, spray coating, and dipping. The coating compositions can be applied at a temperature between room temperature and about 75° C., although temperatures outside this range can also be used.

Any solid substrate compatible with the coating compositions can be coated, such as plastic materials, wood, paper, metal, printed surfaces, leather, glass, ceramics, glass ceramics, mineral based materials and textiles. The coating compositions of the present invention are especially useful as coatings for synthetic organic polymeric substrates in sheet or film form, such as acrylic polymers, poly(ethyleneterephthalate), polycarbonates, polyamides, polyimides, copolymers of acrylonitrile-styrene, styrene-acrylonitrile-butadiene copolymers, polyvinyl chloride, butyrates, polyethylene and the like. Transparent polymeric materials coated with these compositions are useful as flat or curved enclosures, such as windows, liquid crystal display screens, skylights and windshields, especially for transportation equipment. Plastic lenses, such as acrylic or polycarbonate ophthalmic lenses, can also be coated with the compositions of the invention.

The curing of the coating composition of the invention can be achieved by heating or irradiation with actinic radiation, such as an electromagnetic radiation, UV radiation, visible radiation, infrared radiation, electron beam, gamma radiation, and so forth. In an aspect of the invention, UV radiation or an electron beam radiation can be used because it is conducive to improved processing adhesion. Thus, the coating composition of invention can include actinic radiation curable monomer that cures on exposure to actinic radiation.

The cured coatings can exhibit little optical ripple, filter essentially all UV radiation, when optional UV absorbing additives are included in the formulation, exhibit electro-static dissipative properties, selective infrared absorbance, electromagnetic radiation shielding properties and high refractive indices.

### EXAMPLES

The following examples are included to demonstrate various aspects of the invention. Those of skill in the art should, in light of the present disclosure, appreciate that many changes can be made in the specific aspects which are disclosed and still obtain a like or similar result without departing from the spirit and scope of the invention.

Measurement of the relative degree of optical ripple produced by coating compositions in the Examples was accomplished via the following procedure. The coating composition was reduced with solvents and applied to adhesion treated PET film via a Mayer rod to a controlled thickness of 3 micron. The solvent was removed in a controlled fashion and the coating was subjected to actinic radiation effect cure. Abrasion resistant coated PET film samples were then removed. The back surface reflectance was eliminated by pressing black electrical tape to this surface and the resulting visible reflectance spectrum was obtained. The difference between the peak maximum and peak minimum in the reflectance scans were considered indicative of the degree of optical ripple in the final sample. Samples were also evaluated under high intensity fluorescent lamps to evaluate the optical ripple.

The abrasion resistance of coated film samples in the Examples was determined by coating and curing the coated PET film as described in the above paragraph. Subsequent to cure, the surface of the cured coating was rubbed (e.g., about 20 cycles) with #0000 steel wool under about 1000 grams per square inch load. The number of scratches produced was evaluated and a relative score provided. In some cases, Taber abrasion testing was also performed to evaluate the abrasion resistance of the coated samples.

The resistance of the coated film's surface to scratching was evaluated by attempting to scratch the surface of the coating by running pencils of controlled hardness at about 45 degrees under about 500 grams load along the coated film's surface. The coating's surface was evaluated after each series of pencil was tested to determine if the pencil had damaged the coating's surface.

The electro-static dissipative properties of the cured coatings were determined according to ASTM D257 on the cured coating's surface.

The ability of the cured coatings to selectively mediate transmission of infrared radiation in the Examples was determined as follows: cured coatings were placed in the transmission port of a Shimadzu UV/visible spectrophotometer and the light transmission scanned from 380 nm to 1100 nm. The light transmission at 1100 nm was taken as indicative of the percentage of infrared radiation blocked by the coated film.

The resistance of formulations to UV radiation was determined via Xenon arc weather-o-meter testing; wherein the coated plastic is exposed to artificial sunlight and the change in yellowness, haze and light transmission of the coated plastic versus time was monitored.

### Example 1

UV Curable Abrasion Resistant Coating

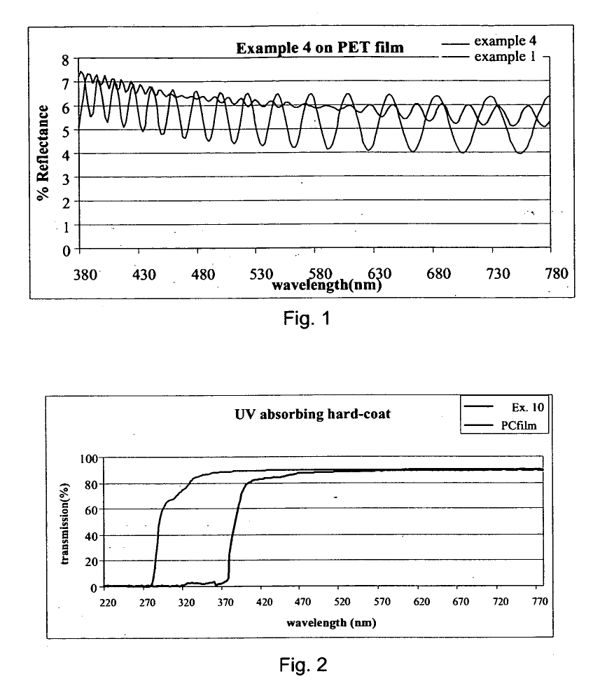

Approximately 15.0 grams of acrylic acid were placed into a tared 250 ml beaker, followed by 85.0 grams dipentaearythritol pentaacrylate and 2.50 grams of a suitable photoinitiator. This admixture was stirred for several minutes until a uniform clear solution resulted. Sufficient isopropyl alcohol and 2-methoxypropanol was added to produce an alcohol born coating solution at 30.0 weight percent solids. This coating was then applied to a continuous web of 3-mil adhesion treated Hostaphan® 4507 with a #4 Mayer coating bar, dried with IR radiation and subjected to curing with UV light. The cured coating exhibited high adhesion, low haze and high light transmission. Upon examination of the reflectance spectrum (FIG. 1) it was noted that the difference between the maximum reflectance and minimum reflectance from a peak to the next adjacent valley was about 3.00 percent. The reflected color of this coated PET film under high intensity fluorescent lighting was green and magenta.

### Example 2

Preparation of UV Curable Abrasion Resistant Coating

Approximately 1.87 grams vinyl caprolactam was added to a small aluminum-weighing pan. This was followed immediately by 6.70 grams of AMT-130S (pH=8.00) from Nissan Chemical America, which is sold at 30.0 weight percent solids as a methanol sol. To this admixture, 6.22 grams of dipentaearythritol pentaacrylate were added followed by a suitable amount of photoinitiator. This dispersion was then diluted to 30.0 weight percent solids by addition of suitable amounts of methanol and dimethyl formamide. Immediately following preparation of this coating dispersion, samples of PET film were coated, dried and cured with UV radiation. These samples exhibited high abrasion resistance, high optical clarity, and low haze. The remaining coating was then placed into an amber storage bottle for 4-days to test the dispersion stability. Coated film samples prepared after this 4-day period were also abrasion resistant, clear and exhibited good adhesion to the PET substrate. The reflectance spectrum of the resulting coated film is in FIG. 1. It should be noted that in this case the difference between the peak and valley height was less than 1.50 percent in this case, therein indicating that a better refractive index between the coating and the substrate had been obtained. (See Table 1)

### Example 3

Preparation of UV Curable Abrasion Resistant Coating

Approximately 1.92 grams vinyl caprolactam was added to a small aluminum-weighing pan. This was followed immediately by 8.33 grams of AMT-130S from Nissan Chemical America, which is sold at 30.0 weight percent solids as a methanol sol. To this admixture, 5.85 grams of dipentaearythritol pentaacrylate were added followed by a suitable amount of photoinitiator. This dispersion was then diluted to 34.0 weight percent solids by addition of suitable amounts of methanol and dimethyl formamide. Immediately following preparation of this coating dispersion, samples of PET film were coated, dried and cured with UV radiation. The reflectance spectrum of the resulting coated film is in FIG. 1. It should be noted that in this case the difference between the peak and valley height was less than 0.40 percent in this case, therein indicating that a better refractive index between the coating and the substrate had been obtained. (See Table 1)

### Example 4

Preparation of UV Curable Abrasion Resistant Coating

Since Nissan Chemical is always developing and marketing newer or improved sols for use in the optical coatings marketplace, a different series of antimony pentoxide sols in methanol were evaluated. To a previously weighed beaker, 1.92 grams of vinyl caprolactam were added followed by 3.00 grams 1,3,5 tris (acryloxyethyl isocyanurate) (SR-368) and stirred until all the SR-368 had dissolved. This was immediately followed by addition of 8.33 grams AMT-330S (pH=6.10) at 30.0 weight percent solids in methanol. While stirring this dispersion vigorously, 2.85 grams dipentaearythritol pentaacrylate were added followed by a suitable amount of photoinitiator. This coating was reduced to 30.0 weight percent solids by addition methanol and diacetone alcohol, coated onto PET film and cured to form an abrasion resistant, clear coating that adhered well to the PET substrate.

### Example 5

Preparation of UV Curable Abrasion Resistant Coating

To a previously weighed beaker, 1.92 grams of vinyl caprolactam were added followed by 8.33 grams of AMT-330S in methanol. While stirring this admixture, 5.85 grams of dipentaearythritol pentaacrylate were added. The dispersion immediately turned hazy, agglomerated and became unusable as an optical coating. While the addition of dimethyl formamide caused the coating solution to clarify, when this dispersion was coated onto PET, dried and cured, hazy coated film samples resulted; thereby indicating that the metal colloid was not stabilized adequately during the coating process and agglomeration of the colloid into particles large enough to scatter light occurred.

### Example 6

Preparation of UV Curable Abrasion Resistant Coating

To a previously weighed large stainless steel beaker, 3147 grams of AMT-130S, 30.0 wt % in methanol were added. This was followed by 757 grams of vinyl caprolactam and stirred until a clear solution resulted. When a uniform solution was apparent, 2069 grams of dipentaearythritol pentaacrylate were added followed by 105 grams of photoinitiator. This dispersion was diluted with 800 grams dimethyl formamide 1540 grams n-propyl alcohol and 725 grams diacetone alcohol. This coating was then stirred until a uniform dispersion resulted. This coating was then applied to 4-mil Hostaphan® 4507 PET film with a number 110 MicroGravure® roll turning at 400 rpm to provide a uniform defect free coated film at 2.34 micron dry film thickness.

After 1-month of storage at approximately 25° C. the remaining coating, 6200 grams, was diluted by addition of 2680 grams diacetone alcohol to about 25.0 weight percent solids and coated onto 4-mil Hostaphan® 4507 film. Clear defect free coatings resulted and the difference in reflected intensity from the peak maximum to the valley minimum was less than 0.40% reflectance.

### Example 7

Preparation of Abrasion Resistance Electro-Static Dissipative Coating

To a previously weighed 100 ml beaker, 1.35 grams of Celnax Cx-Z653M-F (electro conductive oxide 60 weight percent in methanol) were added followed by 1.70 grams vinyl caprolactam. This admixture was stirred several minutes to dissolve the vinyl caprolactam in the Celnax. After dissolution of the vinyl caprolactam was complete, an additional 3.54 grams of Celnax was added to the mixture with stirring. After several minutes of stirring 5.38 grams of di-trimethylolpropane tetraacrylate (SR-355) were added with stirring, followed by 0.32 grams photoinitiator. This admixture was diluted with 5.00 grams methanol and 3.00 grams butoxyethanol.

This dispersion was immediately coated onto adhesion treated PET film, allowed to dry and subjected to UV radiation to affect cure. The coated film exhibited high abrasion resistance, good adhesion to the PET substrate, a pencil hardness of 3H. Due to the absorbing nature of the particles, the visible light transmission was about 81.0 percent with 3.0 to 5.0 percent haze. From the small peak to valley height that was observable from the reflectance spectrum, it was apparent that the refractive index of the coating very closely matched that of the PET film. The coated sample exhibited a surface resistivity of 1.0×10⁹ Ω/sq.

### Example 8

Preparation of Abrasion Resistance Silica Reinforced Coating

To a previously weighed 250 ml beaker, 25 grams of molten 1,3,5 tris (acryloxyethyl isocyanurate), 25 grams acrylic acid, 83.3 grams IPA-ST (Nissan Chemical), 25 grams of dipentaearythritol pentaacrylate and 2.5 grams photoinitiator (Darocur 11732-hydroxy 2-methyl 1-phenyl 1-propanone) were added. This admixture was stirred until a clear low viscosity solution resulted. Coating was reduced to 50 wt % solids with methanol and coated onto PET film (188 micron), the solvent evaporated and cured with a 200 watt/inch UV lamp at 5 meters per minute. A clear, defect free, abrasion resistant, high pencil hardness (greater than 4H) resulted. The measured optical ripple of this coating was less than 1.25 percent from the peak maximum to the minima; furthermore, observation under high intensity fluorescent lamps showed that observable degree of optical ripple was less than that of commercially available abrasion resistant coatings on PET film.

Using the previously mentioned blending procedure, 100 grams of silica reinforced UV curable coating was prepared which contained 30, 35, 40 and 50 weight percent silica in the dried coating. These coatings, when cured, were clear, haze free, very hard and extremely resistant to abrasion and showed little to no optical ripple when evaluated under fluorescent lamps or when measured using a UV spectrophotometer.

### Example 9

Preparation of Abrasion Resistant Silica Reinforced Coating

To a previously weighed amber glass bottle, 13.50 grams of molten 1,3,5 tris (acryloxyethyl isocyanurate), 13.50 grams acrylic acid and 27.25 grams of Nanopol XP21/1264 (50 wt % colloidal silica in PM acetate) were added. This mixture was stirred until a clear uniform solution resulted. When mixing was complete, 15.30 grams of dipentaearythritol pentaacrylate and 1.22 grams of Darocur 1173 photoinitiator (2-hydroxy 2-methyl 1-phenyl 1-propanone) were added. This mixture was stirred until a completely clear uniform coating solution resulted. Polycarbonate film (375 micron thickness) was coated with this solution at a wet thickness sufficient to provide a dry coating of 3 microns, dried with IR radiation and subjected to UV cure with a 200 Watt/in H-type UV lamp. Subsequent to cure the pencil hardness, adhesion and other physical properties were evaluated. The pencil hardness was measured to be 2H according to the test methods employed at VOCI, resistance to abrasion was excellent and adhesion was again excellent to the polycarbonate substrate.

To a previously weighed beaker, 9.32 grams of 1,3,5 tris (acryloxyethyl) isocyanurate and 9.00 grams of THF acrylate (SR-285) were added. This mixture was heated at 80° C. until all the isocyanurate had dissolved. When dissolution was complete, 19.50 grams of Nanopol XP 21/1264 (50 wt % colloidal silica in PM acetate) and 10.25 grams of an epoxy novalac acrylate-trimethylolpropane triacrylate blend (CN112C60 from Sartomer Company) and suitable amounts of photoinitiator were added. When this composition was completely mixed, 375-micron polycarbonate film was coated, dried and cured to provide a film with a dry coating weight of 4 microns. The pencil hardness of this coated film was measured to be 3H according to the tests employed. The abrasion resistance and adhesion of the cured sample was again excellent.

### Example 10

Preparation of UV Filtering UV Curable Abrasion Resistant Coating

To a tared beaker 25.12 grams of coating from example 7 were added (65 weight percent solids). This was followed immediately by 0.50 grams of Eversorb 74, a benzotriazole type UV absorber and 10.0 grams of methanol. This composition was allowed to stand until all the UV absorber had dissolved and the coating was filtered through a 0.45 um Teflon® syringe filter. PET film (188 um) was coated, dried with IR radiation and cured using a 200W/in H-type UV lamp in air.

FIG. 2 shows the UV transmission properties of this coated PET film sample was compared to uncoated PET film and to commercially available ‘UV cut’ PET films. The UV transmission of this coating was 4.0% at 380 nm, compared to 84.0% for uncoated PET film. The pencil hardness was measured to be greater than 3H, the resistance to steel wool abrasion and adhesion were also found to be excellent. In this case, Taber abrasion resistance (500 gram load, CS-10F wheels, 100 cycles) was also measured—the change in haze subsequent to testing was found to be less than 2.00% change in haze as compared to greater than 20.0% change for uncoated PET and greater than 5.0% change in haze for standard UV curable abrasion resistant coated film samples.

### Example 11

Preparation of UV Curable Abrasion Resistant Coating (Control)

To a tared 250 ml beaker, 25 grams of acrylic acid were added followed by 83 grams IPA-St from Nissan Chemical. This admixture was blended until a clear low viscosity solution resulted; subsequently, 50 grams of dipentaearythritol pentaacrylate and 3 grams photoinitiator were added. This coating, while clear, was gelatinous in nature and could not be coated to yield clear defect free coatings via flow, dip or Mayer rod coating due to its extremely high viscosity.

### Example 12

Preparation of Infrared Blocking/ESD Coatings

To a tared amber bottle, 1.78 grams of 1,3,5 tris(acryloxyethyl isocyanurate) were added. This was followed by an admixture containing 9.22 grams Celnax Z-653 MF in methanol (60-wt % solids) mixed with 0.60 grams vinyl pyrollidinone under rapid stirring. Sufficient Darocur 1173 was added to effect rapid cure under actinic radiation. Cured films resulting from application, drying and cure of this coating contained 70 wt % zinc antimony nano-particles. Using the procedure above, coatings were prepared that contained: 43, 45, 47, 50, 53, 60 and 70 weight percent zinc antimony nano-particles in the cured coatings—the physical, optical and electrical properties are summarized in Table 2.

### Example 13

Preparation of Infrared Blocking Coating

To a tared beaker 5.42 grams 1,3,5 tris(acryloxyethyl isocyanurate) followed by 1.58 grams tetrahydrofurfuryl acrylate (SR-285) were added and heated until the solids monomer had completely melted. 28.00 grams of a commercially available indium tin oxide colloidal oxide dispersion in water (25 weight percent), S22n from Nanogate® GmbH was added to a tared beaker followed by 20.00 grams isopropyl alcohol, 8.00 grams cyclohexanone and sufficient photoinitiator to effect cure. The resulting cured coating was clear, exhibited high visible light transmission, little color and excellent infrared blocking properties. (see Table 2)

TABLE 1
Representative Properties of Examples

| | Metal | Weight % | | Change | % LT | |
|---|---|---|---|---|---|---|
| | oxide | metal | Reactive | in peak | at | Pencil |
| Example # | type | oxide | diluent(s) | height | 380 nm | hardness |
| 1 | NA | 0.00 | Acrylic acid | 3.00% | NM | 2H |
| 2 | Sb₂O₅ | 20.00 | Vinyl | 1.40% | NM | 3H |
| | | | caprolactam | | | |
| 3 | Sb₂O₅ | 25.00 | Vinyl | 0.40% | NM | 3H |
| | | | caprolactam | | | |
| 4 | Sb₂O₅ | 25.00 | Vinyl | 0.40% | NM | NM |
| | | | caprolactam | | | |
| | | | & SR-368 | | | |
| 5 | Sb₂O₅ | 25.00 | Vinyl | Hazy | NM | NM |
| | | | caprolactam | | | |
| 6 | Sb₂O₅ | 25.0 | Vinyl | 0.40% | NM | NM |
| | | | caprolactam | | | |
| 7 | Celnax | 35.00 | Vinyl | 0.20 | NM | NM |
| | | | caprolactam | | | |
| 8 | SiO2 | 25.00 | SR-368 | <1.25% | >84% | >3H |
| | (IPA-ST) | | | | | |
| 9 | SiO2 | 25.00 | SR-368 | <1.25% | NM | 3H |
| | (Nanopo I) | | | | | |
| 10 | IPA-ST | 25.00 | SR-368 | NM | <5% | 3H |
| 11 | IPA-ST | 25.00 | None | Gel | Gel | Gel |
| PET film | NA | 0.00 | NA | NA | >84.0% | HB to H |

NM = Not measured

TABLE 2
Representative Examples of Infrared Blocking/ESD coatings

| | Oxide | | | | Surface |
|---|---|---|---|---|---|
| | type/wt | | % LT at | | resistivity |
| Example # | percent | % VLT | 1100 nm | % Haze | (□/sq.) |
| 12 | ATO/43 | NM | NM | <1.00% | 6.1 × 10⁸ |
| 12 | ATO/45 | NM | NM | <1.00% | 4.1 × 10⁸ |
| 12 | ATO/50 | 83.0 | 60.0% | <1.00% | 1.1 × 10⁸ |
| 12 | ATO/60 | 80.0% | 55.0% | <1.00% | 6.0 × 10⁷ |
| 12 | ATO/70 | 75.0% | 30.0% | <1.00% | 1.1 × 10⁷ |
| 13 | ITO/50 | >75.0% | <10.0% | <1.00% | NM |

1. A silane-free coating composition comprising:
a polar aprotic reactive diluent
a colloidal inorganic oxide; and
a crosslinkable monomer that has a functionality of at least one.

2. The coating composition of claim 1, the diluent comprising a cyclic tertiary amide.

3. The coating composition of claim 2, tertiary amide comprising at least one of a lactam or isocyanurate.

4. The coating composition of claim 1, the diluent including at least one of 1,3,5 tris (acryloxyethyl isocyanurate), vinyl pyrollidinone, vinyl caprolactam, or tetrahydrofurfuryl acrylate.

5. The coating composition of claim 1, the colloidal inorganic oxide comprising an oxide of an atom selected from the group consisting of silicon, aluminum, titanium, zinc, germanium, indium, tin, antimony, and combinations thereof, the colloidal inorganic oxide.

6. The coating composition of claim 1, the colloidal inorganic oxide being present in the form of a sol and having a pH between about 1 and about 10.

7. The coating composition of claim 1 wherein the colloidal inorganic oxide comprises at least one of a silica sol with an acidic pH, a colloidal antimony pentoxide sol, or a colloidal zinc antimony oxide sol.

8. The coating composition of claim 1, comprising by weight on a solids basis about 1% to about 75% of the colloidal inorganic oxide.

9. The coating composition of claim 1, further comprising at least one of a solvent, UV absorber, infrared absorber, or a polymerization initiator.

10. A silane-free coating composition comprising:
a polar aprotic reactive diluent, the diluent including a cyclic tertiary amide;
a colloidal inorganic oxide; and
a multifunctional crosslinkable monomer.

11. The coating composition of claim 11, the diluent being a multifunctional crosslinkable monomer.

12. The coating composition of claim 12, the diluent being an isocyanurate.

13. The coating composition of claim 10, the multifunctional monomer comprising an acrylate monomer.

14. The coating composition of claim 10, the colloidal inorganic oxide comprising an oxide of an atom selected from the group consisting of silicon, aluminum, titanium, zinc, germanium, indium, tin, antimony, and combinations thereof, the colloidal inorganic oxide being provided in the form of a sol having a pH between about 1 and about 10.

15. The coating composition of claim 10, comprising by weight on a solids basis:
about 1% to about 75% of the colloidal inorganic oxide;
about 20% to about 60% of the multifunctional monomer;
about 5% to about 55% of the diluent.

16. The coating composition of claim 10, further comprising at least one of a solvent, UV absorber, infrared absorber, or a polymerization initiator.

17. A silane-free coating composition comprising by weight on a solids basis:
about 5% to about 55% of a polar aprotic reactive diluent, the diluent including an isocyanurate;
about 1% to about 75% of a colloidal inorganic oxide;
about 20% to about 60% of a multifunctional crosslinkable monomer.

18. The coating composition of claim 17, the diluent and the crosslinkable monomer comprising of 1,3,5 tris (acryloxyethyl isocyanurate).

19. The coating composition of claim 17, further comprising at least one of a solvent, UV absorber, infrared absorber, or a polymerization initiator.

20. A cured product produced by curing the coating composition of claim 17.
